(19) United States
(12) Patent Application Publication
(10) Pub. No.: US 2007/0264855 A1
(43) Pub. Date: Nov. 15, 2007

(54) Constructional facing element

(76) Inventor: Marco Doppioni, Benicassim (ES)

Correspondence Address: THOMPSON & KNIGHT, L.L.P.;PATENT PROSECUTION GROUP, 1700 PACIFIC AVENUE, SUITE 3300, DALLAS, TX, 75201, US

(21) Appl. No.: 11/803,596

(22) Filed: May 15, 2007

(30) Foreign Application Priority Data
May 15, 2006 (ES) U 200601173

(51) Int. Cl. H01R 13/52

(52) U.S. Cl. 439/271

(57) ABSTRACT

A facing element, such as a brick or floor tile suitable for forming a constructive part of a structure, includes at least one face that presents an ornamental or functional termination and at least one other face that presents cavities that extend toward the interior of the body of the element for reducing the weight of the element.

As its name indicates, the present invention refers to a constructional element, such as a brick or a tile, wherein at least one of the faces that will be exposed after being set in place in the structure presents an ornamental or functional finish in relief, preferably bas-relief, and wherein a series of cavities have been made in at least one of its free faces that improve its grip on the structure, besides lightening the piece itself without impairing its strength and hardness.

El engineering sector in which this invention will be applied is that of construction.

### BACKGROUND OF THE INVENTION

It is standard practice in construction to wish to endow such surfaces as walls, floors or, as the case may be, ceilings with ornamental elements.

It is also normal to try and include safety elements in certain surfaces that will, for instance, improve grip on ramps and slippery surfaces.

Traditionally, this result has been achieved by means of application to the structure of tiles or borders that comply with the desired ornamental or functional requirements.

These borders or special tiles, however, may create problems of grip to the structure causing them to drop off, or else, if they are used in areas that have to withstand impacts or weights, they usually crack easily.

Furthermore, these borders or tiles necessarily entail an addition to the surface to which they grip and from which they stand proud, so that, if this surface is entirely clad, tiled or flagged for instance, they may be fitted flush but this will prove impossible on dressed or facing brick surfaces.

To overcome the above-mentioned problems an invention is presented that permits the placement of ornamental or functional elements on dressed or facing brick surfaces.

### DESCRIPTION OF THE INVENTION

The invention proposed here consists essentially of a constructional element of the type of those forming part of the actual construction, being integrated into same and not merely cladding or adhering to it, wherein at least one of its faces presents an ornamental or functional finish and wherein cavities have been made that not only lighten its weight without impairing its strength, but also increase its grip to the structure as the mortar penetrates into the interior of the piece, thereby forming a single body.

The ornamentation or functionality that is exhibited on the exposed face or faces of the piece may form part of a decorative or ornamental continuity.

As a rule, the piece will have one of its faces with the desired ornamental or functional termination, while the cavities are made in one of the faces that remains concealed.

However, as proposed, the invention may have more than one ornamental or functional face, so that it may be used, when appropriate, for example at angle edges or in thin partition walls, where the same structural piece is seen from both sides of the wall.

In the case of a piece like those mentioned which have their ornamental or functional faces opposed, the cavities that help to lighten the piece should be made in the faces that do not have such special terminations.

### BRIEF DESCRIPTION OF THE FIGURES

The figures that are proposed present a form of embodiment of the piece wherein only one of its faces offers an ornamental or functional termination, while the cavities are made in the opposite face. This however is only one form of execution of the invention, which may present several others, as explained above.

FIG. 1 shows a view of the piece wherein we observe its parallelepiped shape, a shape of brick suitable for its integration in the actual structure, the case being that one of its faces (2) presents an ornamental finish, which could also be functional, and all the other ones that are seen in this representation present a plain finish (3).

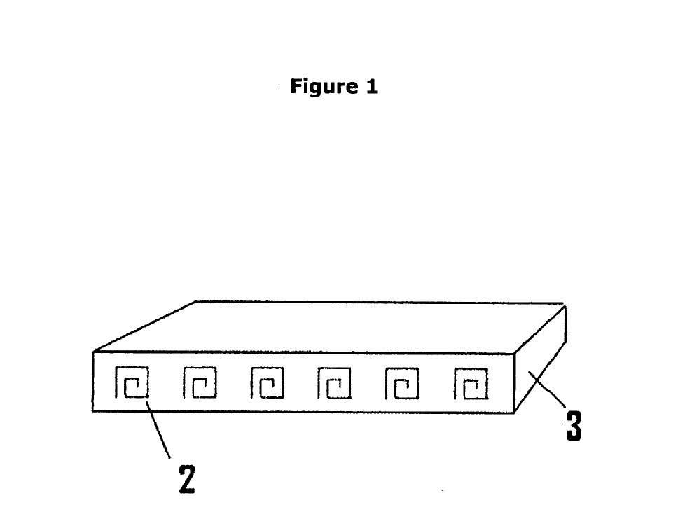

FIG. 2 shows an upper view of the piece, wherein the cavities made in one of its faces are shown with a dotted line.

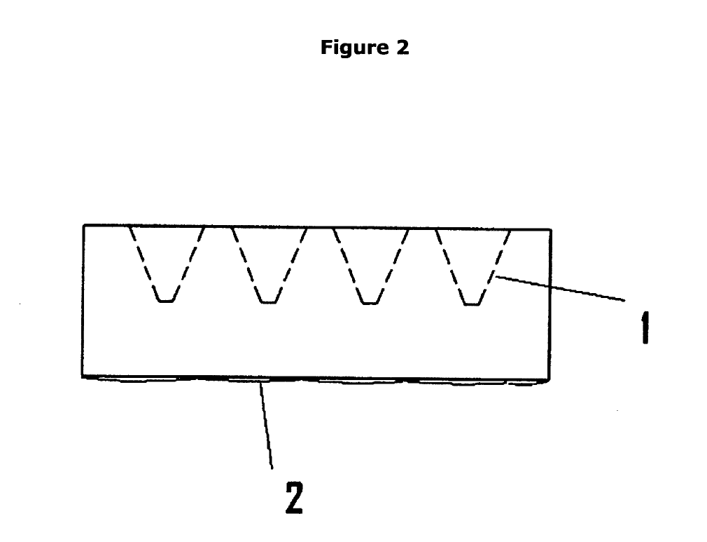

FIG. 3 shows a section of the piece at a point coinciding with the bisector of one of the cavities made.

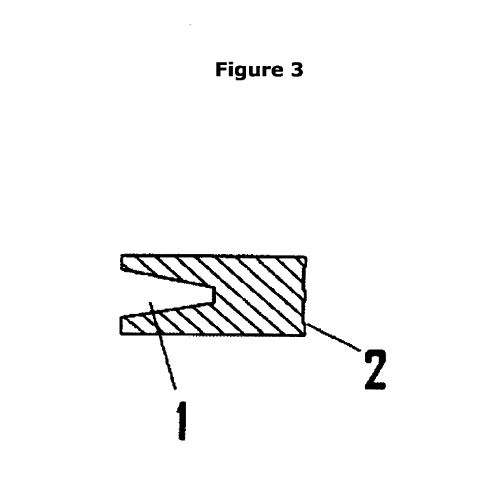

### DESCRIPTION OF THE BEST MODE OF EMBODIMENT OF THE INVENTION

In this section we are going to describe one mode of embodiment of the invention, without prejudice to the fact that it may be executed in various ways, depending on the number of faces that present a decorative or functional finish as well as on the location of the cavities.

The invention proposed here is a construction piece made from any suitable material such as clay or porcelain, for example, or any other one found to be suitable for the use to which it is to be put.

The end dimensions of the piece will be determined in each case by the needs to be met.

The piece proposed is intended to be integrated into the actual structure, which differentiates it from other ornamental or functional pieces for cladding surfaces which adhere to the structure proper. This facilitates its placement as it does not represent an addition to the structure but replaces the standard piece that would form part of the structure.

In the mode of the embodiment explained here, the invention proposed has one of its faces with a special (2), ornamental or functional termination, wherein said special termination will usually consist of a series of reliefs or hollows making up the desired patterns or shapes to comply with ornamental or practical function of the piece.

The special face of the piece may assume a chromatic termination.

Another of the faces of the piece, normally the one opposite the special ornamented face, houses a series of cavities (1) which enable the weight of the piece to be lightened without impairing its strength on account of their special pyramid shape.

These rectangular-based, pyramid-shaped cavities proposed may take on such other shapes as either the triangular-, square- or frustoconical-based pyramid.

The aforesaid cavities may go in any of the faces of the piece that is concealed when the piece is set in place in the structure.

When the piece is set in place in the structure, the cavities are at least partly filled with mortar or gripping material used, thereby generating a stronger union of the piece to the structure.

The faces that are not affected by an ornamental or functional termination or by the above-mentioned cavities (3) will usually have one plain termination or, if appropriate, a surface with a roughness or pattern that will facilitate its grip to the structure.

1. IMPROVED FACING CONSTRUCTIONAL ELEMENT of the type of bricks or floor tiles that are integrated into the structure, forming a constructive part of same and not merely cladding it, characterised essentially in that at least one of its faces (2) presents an ornamental or functional termination and at least another of the remaining faces presents cavities (1) that extend towards the interior of the body of the piece, thus lightening its weight.

2. IMPROVED FACING CONSTRUCTIONAL ELEMENT according to the previous claim, characterised essentially in that the ornamental or functional termination that is presented by at least one of its faces (2) is in relief, preferably in bas-relief.

3. IMPROVED FACING CONSTRUCTIONAL ELEMENT according to the previous claims, characterised essentially in that the ornamental or functional termination of its exposed face or faces vistas may be either separate from other similar pieces or form an ornamental or functional whole with other parts, pieces or elements of the structure or its covering.

4. IMPROVED FACING CONSTRUCTIONAL ELEMENT according to the first claim, characterised essentially in that a cavity (1) or a series of cavities that produce the effect of voiding the piece have been made in at least one of its non-ornamented faces.

5. IMPROVED FACING CONSTRUCTIONAL ELEMENT according to the previous claim, characterised essentially in that, once installed in the structure, the aforesaid cavities are at least partly filled with gripping material, thereby assuring a strong attachment of the piece to the structure.
